(19) United States
(12) Patent Application Publication
(10) Pub. No.: US 2011/0293021 A1
(43) Pub. Date: Dec. 1, 2011

(54) PREVENT AUDIO LOSS IN THE SPLICED CONTENT GENERATED BY THE PACKET LEVEL VIDEO SPLICER

(76) Inventors: Jayant Kotalwar, Sunnyvale, CA (US); Punitma Malhotra, Cupertino, CA (US)

(21) Appl. No.: 12/790,218

(22) Filed: May 28, 2010

(51) Int. Cl. H04N 7/26

(52) U.S. Cl. 375/240.26; 375/E07.026

(57) ABSTRACT

A method and apparatus for packet level splicing of transport streams including encrypted content wherein the audio packets having a presentation timestamp (PTS) value greater than that of a last video frame within the primary or from-stream are dropped prior to splicing.

### FIELD OF THE INVENTION

This invention relates to communication systems in general and, more particularly, to a method and apparatus for packet level splicing of compressed data streams.

### BACKGROUND

Fast channel change (FCC) is a desirable set-top box function for quickly changing the channel associated with audiovisual information presented to a display device such as a television. In the case of a digital television system, presenting a desired channel comprises demultiplexing or otherwise selecting a transport stream associated with the desired content, extracting from the transport stream the encoded video and audio streams associated with the desired content, decoding these encoded video and audio streams, and presenting the decoded video and audio information via a presentation device, such as a television system or home theater. Importantly, the FCC operation should be performed with as few noticeable video or audio disturbances/artifacts as possible. Stated differently, the transition between channels or, more particularly, the audiovisual streams representing the particular channels should be made in a substantially seamless manner.

It is known to splice MPEG-2 video streams in a substantially seamless manner to concatenate thereby two MPEG-2 video streams.

The first (initial) of the two concatenated video streams is known as the from-stream, while the second (subsequent) of the two concatenated video streams is known as the to-stream. Ideally, a splicing operation is performed where the last frame of the from-stream comprises a P-frame or B-frame toward the end of a group of pictures (GOP) boundary, while the first frame of the to-stream comprises an I-frame. This is beneficial for two reasons. First, buffer underflow or overflow conditions at the decoder are (hopefully) avoided, since there is likely no large increase or decrease in the decoder buffer utilization level. Second, by entering the to-stream at an I-frame, the subsequent P-frames and B-frames are correctly predicted, thereby avoiding any visual artifacts.

Splicing is presently performed at the elementary stream level wherein the encoded video frames are processed to identify appropriate splice-out points in the from-stream and splice-in points in the to-stream, which points are used to transition between the from- and to-streams to provide thereby a concatenated elementary stream.

Unfortunately, within the context of encrypted audiovisual streams, the processing of MPEG-2 video streams becomes extremely difficult due to the inability to access information due to encryption of that information. For example, in systems utilizing in-stream markers, flags or other data elements indicative of splicing in-points and out-points, those markers, flags or other data elements may no longer be available for inspection due to encryption of such information.

Further, within the context of MPEG-2, MPEG-4 and other audiovisual encoding technologies, the resulting encoded bitstream includes packets associated with video information and packets associated with audio information. To ensure that the appropriate audio packets are available at the decoder in time to be decoded along with the relevant video packets, audio packets are often transmitted before their corresponding video packets. This reordering of video and audio packets may result in a condition where audio packets are transmitted a full second before their corresponding video packets. In this case, audio packets associated with the initial or from-stream may be presented along with video frames from the subsequent or to-stream, resulting in undesirable audio artifacts and other anomalies.

### BRIEF SUMMARY

Various deficiencies of the prior art are addressed by the present invention of a packet level video splicer that monitors a primary or from-stream and, prior to a splice operation, removes those audio frames which have presentation timestamp (PTS) values greater than the PTS of the last video frame within the primary or from-stream.

A method according to one embodiment for splicing transport streams including encrypted audiovisual information to provide a concatenated transport stream, the method comprises receiving, at a splicer, a control signal indicative of a desire to change output transport streams after a specific from-stream transport stream packet; identifying a presentation timestamp (PTS) of a final video frame of the from-stream; discarding from the from-stream those audio packets associated with any audio access unit having a PTS greater than the PTS of the final video frame of the from-stream.

In various embodiments, the from-stream may comprise a network feed and the to-stream may comprise an advertisement to be inserted therein. The streams may comprise RTP packets encapsulating non-RTP transport packets including encrypted MPEG-2 or MPEG-4 video and audio elementary streams.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a system according to one embodiment;

FIG. 2 depicts a packet structure useful in implementing several embodiments of the present invention;

FIG. 3 depicts a flow diagram of a method 300 for generating a packet structure such as depicted in FIG. 2;

FIG. 4 depicts a flow diagram of a method for splicing or concatenating two compressed streams;

FIG. 5 depicts a high-level block diagram of a system according to another embodiment; and

FIG. 6 depicts a high-level block diagram of a computing element suitable for use in performing various functions described herein.

To facilitate understanding, identical reference numerals have been used, where possible, to designate identical elements that are common to the figures.

### DETAILED DESCRIPTION OF THE INVENTION

The invention will be primarily described within the context of a system for splicing audiovisual streams structured as MPEG-2 transport streams encapsulating or otherwise conveying encrypted MPEG-2, MPEG-4, or other encoded/compressed elementary streams (video and audio access units). The MPEG-2 transport streams are primarily described as being conveyed according to the Real-time Transport Protocol (RTP) conventions. However, those skilled in the art and informed by the teachings herein will realize that the invention is also applicable to various types of transport mechanisms, encoding mechanisms, encryption mechanisms and the like.

Generally speaking, the various embodiments provide a packet level video splicer that monitors a primary stream or from-stream and, prior to a splice operation, removes those audio packets/frames which have presentation timestamp (PTS) values greater than the PTS of the last video frame within the primary stream or from-stream.

Broadcast/Network Television Embodiments

Within the context of an exemplary broadcast television system, each television network transmits the content of each of its various channels or network feeds within transport streams (TS) via, illustratively, an Internet Protocol (IP) network supported by various core and access networks. A subscriber selects or tunes a particular transport stream based upon the desired content. The selected transport stream is demultiplexed to extract therefrom video information, audio information, program information, metadata and the like. The video and audio information extracted therefrom is decrypted as necessary, decoded and subsequently presented. The audiovisual presentation of a television channel typically comprises content portions and advertisement portions.

Applications like fast channel change (FCC) acquire picture frames and immediately decode and present them. These applications need access to a picture frame's video and audio buffers almost simultaneously. Since a lag in the arrival of audio frames could result in lack of audio in the displayed picture, video servers often use an audio reorder mechanism wherein audio frames or packets are reordered in terms of transmission time such that the audio frames or packets are moved closer to the corresponding video frames. That is, the normal position of the audio packets within the transport stream is reordered such that audio packets within the transport stream may be transmitted prior to the corresponding video frames.

Splicers are used to insert advertisement stream or other content into a received network stream, such as for replacing national or global advertisements with locally relevant advertisements. Such splicers may be located at a router associated with an access network serving a group of subscribers, an edge router and the like. Where the network stream is audio reordered, it is possible that the resulting spliced audiovisual streams may include audio packets associated with pre-splice video frames.

If audio packets associated with a future network stream video frame are decoded and presented along with a present advertisement stream video frame, then the subscriber will experience incorrect audio information and/or unpleasant audio artifacts. For example, the audio could become choppy, there could be a complete loss of audio due to the mismatch of timestamps and/or there could be an underflow condition of the audio buffers in the decoder. A similar condition may occur where a splicer switches from a first advertisement to a second advertisement.

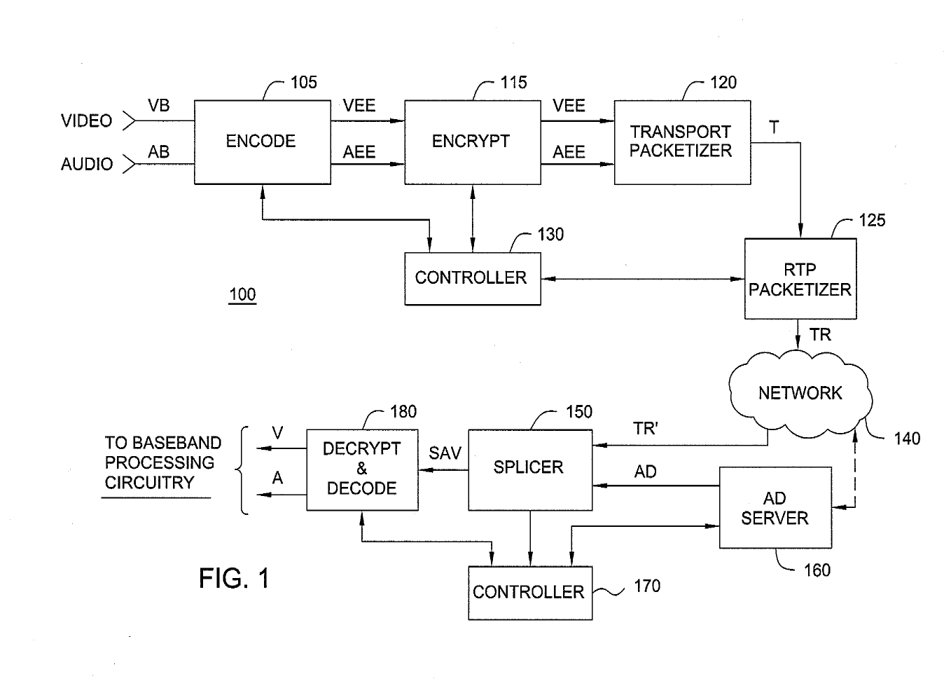

FIG. 1 depicts a high-level block diagram of a system 100 according to one embodiment. The system 100 includes transmission/server-side functionality adapted to encapsulate content-bearing transport packets within an RTP packet format for subsequent transmission through a network 140 toward receiver/client-side functionality.

It will be appreciated that certain functional elements of the system 100 of FIG. 1 have been omitted to simplify the discussion. For example, various buffers, optical to electrical signal converters, electrical to optical signal converters, level translators and the like have been omitted for clarity.

### Transmission/Server-Side Functionality

An encoder 105 encodes a baseband video signal VB and a baseband audio signal AB to provide thereby encoded video signal VE and encoded audio signal AE. The encoder 105 may comprise an MPEG-2 encoder, an MPEG-4 encoder, an H.264 encoder and the like. Generally speaking, encoder 105 operates to encode baseband video and audio streams to provide encoded/compressed video and audio streams.

An encryptor 115 operates to encrypt the encoded video signal VE and encoded audio signal AE to provide encrypted/encoded video signal VEE and encrypted/encoded audio signal AEE. Any of any number of encryption algorithms or techniques may be utilized, such as the Data Encryption Standard (DES), Triple DES or any other standard or proprietary encryption method.

A transport packetizer 120 operates to packetize the encrypted/encoded video signal VEE and encrypted/encoded audio signal AEE to provide a corresponding transport stream T. The transport packetizer 120 may comprise an MPEG-2 or other transport packetizer.

A real-time protocol packetizer 125 operates to encapsulate into RTP packet format the packets within the transport stream T to provide a stream or sequence of RTP encapsulated transport packets TR to the network 140 for subsequent transmission towards subscribers or clients.

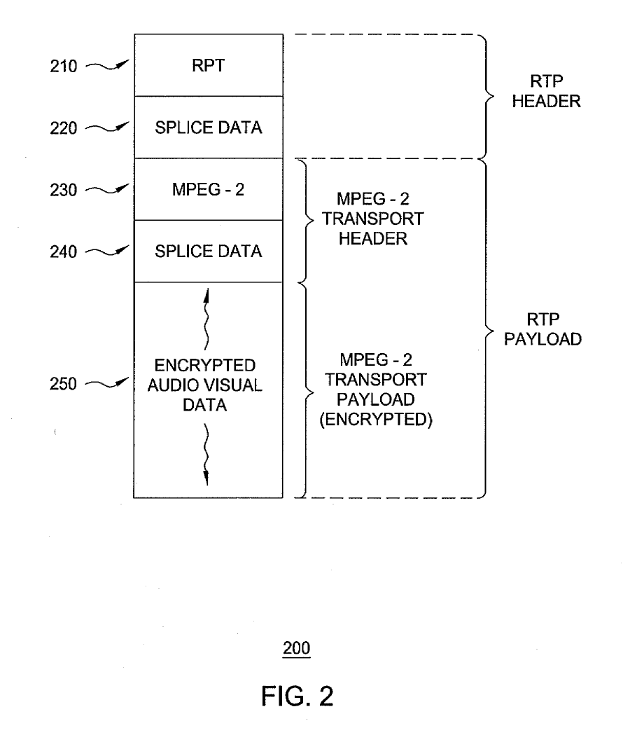

A controller 130 is in communication with one or more of the encoder 105, encryptor 115, transport packetizer 120 and RTP packetizer 125. The controller 130 adapts the operation of the various functional elements under its control to ensure that resulting transport package and/or RTP packets are of an appropriate structure, such as described below with respect to FIG. 2.

The controller 130 cooperates with the encoder 105, encryptor 115 and/or transport packetizer 125 to identify GOP boundary conditions and/or other splice related data. The controller 130 provides the identified GOP boundary conditions and/or other splice-related data to the transport packetizer 120 and/or the RTP packetizer 125, where a corresponding indicator flag or other mechanism is provided within a header extension.

In one embodiment, the controller 130 operates to cause the RTP packetizer 125 to include within the RTP packet encapsulating the content-bearing transport packets a header extension providing a flag or other mechanism to store splice data related to the encapsulated content. In another embodiment, the controller 130 operates to cause the transport packetizer 122 to include within the content-bearing transport packets a header extension providing a flag or other mechanism to store splice data related to the content.

Splice data stored in either or both of the RTP packet header or transport packet header may comprise an indication of whether the encapsulated content includes one or more packets associated with an I-frame, the end of the GOP, the beginning of the GOP, a splice-in point, a splice-out point or some other splice related data.

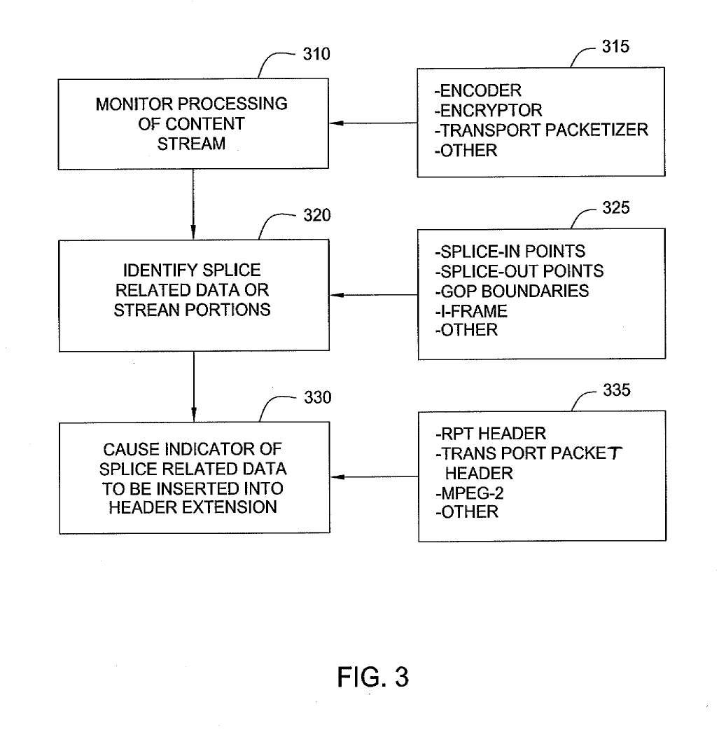

That is, the controller 130 causes either or both of the transport packetizer 120 and RTP packetizer 125 to include a respective header extension including an indicator of an I-frame, any GOP boundary condition, splice-endpoint, splice-out point and/or other splice related data. A method for performing this function is described in more detail below with respect to FIG. 3.

FIG. 2 depicts a packet structure useful in implementing several embodiments of the present invention. Specifically, FIG. 2 depicts a Real-time Transport Protocol (RTP) packet structure 200 which includes a header portion and a payload portion. The RTP header portion is depicted as comprising a standard RTP header 210 and an optional splice indicator header extension 220.

The RTP payload portion is depicted as comprising an MPEG-2 transport packet including a respective header portion and payload portion. The MPEG-2 header portion is depicted as comprising a standard MPEG-2 header 230 and an optional splice indicator header extension 240. The MPEG-2 payload portion is depicted as comprising encrypted/encoded audiovisual data 250. Included within this encrypted audiovisual data 250 are decoded timestamps (DTS), presentation timestamps (PTS) and other elementary stream information. It is noted that the DTS and PTS information is normally included within an adaptation header within the packetized elementary stream (PES).

Thus, in various embodiments the splice indicator data associated with the encrypted audiovisual data is included within one or both of the RTP splice indicator header extension 220 and MPEG-2 splice indicator header extension 240.

It is noted that the RTP packet structure of FIG. 2 contemplates the use of MPEG-2 transport packets encapsulated therein. Generally speaking, any type of transport packet including packetized elementary streams may be used for this purpose. Thus, encapsulating packet structure may comprise an RTP packet structure, an MPEG-2 packet structure or any other encapsulating packet structure appropriate to the particular network through which the packets are transmitted. The transport packet structure may comprise an MPEG-2 packet structure or any other transport packet structure suitable for including packetized elementary streams therein. Thus, in one embodiment of the invention, the RTP packet structure encapsulates a non-RTP packet structure, illustratively MPEG-2 or other transport packet structure.

It is noted that the RTP packet structure of FIG. 2 contemplates a single MPEG-2 transport packet encapsulated therein. In various embodiments multiple MPEG-2 transport packets are encapsulated within a single RTP packet. In other embodiments, different transport packet structures or mechanisms are utilized rather than the depicted MPEG-2 transport packet. Generally speaking, one RTP packet may include multiple MPEG-2 or MPEG-4 video access units and/or audio access units. Whether a particular portion of the RTP payload includes an I-frame, P-frame or B-frame may not be known due to encryption.

Furthermore, common sizing for GOP structures ranges from 1 to 10 seconds. For example, a 1 second GOP includes a number of video frames (and associated audio data) to provide a 1 second presentation of the encoded video content, such as 60 video frames within the context of a 60 frame per second (FPS). Assuming an 8 Mb per second traffic rate, there will be approximately 11 or 12 RTP packets per second transmitted. Thus, in one embodiment each RTP packet typically includes seven transport stream packets, where each of the transport stream packets can include portions of video access units or audio access units.

FIG. 3 depicts a flow diagram of a method 300 for generating a packet structure such as depicted in FIG. 2 using the transmission/server-side functionality described above with respect to FIG. 1.

At step 310, the controller 130 monitors the processing of a content stream. Referring to box 315, such monitoring may comprise monitoring the encoder 105, encryptor 115, transport packetizer 120 and/or other functionality associated with the processing of a content stream.

At step 320, the controller 130 identifies splice related data and/or stream portions associated with splice related data within the content stream being processed. Referring to box 325, such splice related data may comprise splice-endpoints, splice-out point, GOP boundary conditions, I-frame and/or other splice related data.

At step 330, the controller 130 causes an indicator of the splice related data to be inserted into a header extension or other portion of the packetized data to be conveyed to a subscriber or client. Referring to box 335, the splice related data may be inserted into an RTP header extension, the transport packet header extension, and MPEG-2 transport packet header extension and/or some other non-encrypted portion of the packetized data to be conveyed to a subscriber or client.

### Receiver/Client-Side Functionality

Referring back to FIG. 1, the receiver/client-side functionality will now be described in more detail. It will be appreciated that while a single receiver/client is described, the network 140 normally conveys network streams to many subscribers or clients. Moreover, while the receiver/client-side functionality described below is primarily described within the context of a client device, such functionality or portions thereof (e.g., advertisement insertion/splicing functionality) may also be implemented at an edge router, access network router or other network element or switching device in communication with the receiver/client.

A stream or sequence of RTP encrypted transport packets TR′ is received at a first input of a splicer 150. An advertising server 160 couples an advertising stream AD to a second input of the splicer 150. The splicer 150, in response to a signal provided by a controller 170, operates to selectively couple encoded audiovisual information from the first splicer input or the second splicer input to a decryptor/decoder 180. That is, the splicer 150 selectively concatenates portions of the RTP encrypted transport packet stream TR′ and advertising stream AD to provide a concatenated or spliced audiovisual stream SAV, which is coupled to the decryptor/decoder 180. The decryptor/decoder 180 decrypts (if necessary) and decodes the spliced audiovisual stream SAV to provide corresponding video V and audio A streams for use by subsequent baseband processing circuitry (not shown).

The controller 170 cooperates with the splicer 150, advertising server 160 and/or decryptor/decoder 182 to identify splice data embedded within the RTP header portions and/or transport packet header portions of the stream or sequence of RTP encrypted transport packets TR'. The controller 170 causes the splicer 150 to discard audio packets associated with audio access units having a presentation time stamp (PTS) greater than a PTS of a last video stream within a from-stream. That is, the controller 170 causes audio packets having a PTS associated with video frames after a splice point to be dropped prior to splice operation or, optionally, after the splice operation.

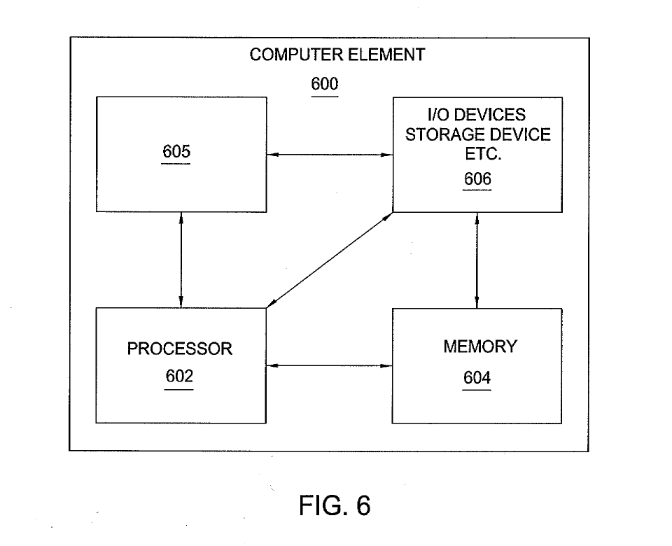

Various functional elements described above with respect to FIG. 1 may be implemented computer hardware via general-purpose or specific purpose computing devices. Examples of computer implementations will be described below in more detail with respect to FIG. 6. Generally speaking, the functional elements discussed herein (i.e., encoder 105, encryptor 115, transport packetizer 120, RTP packetizer 125, controller 130, network 140, splicer 150, ad server 160, controller 170, decryptor/decoder 180 and so on) are implemented in hardware, software and/or a combination thereof. As previously noted, portions of the functional elements are not discussed in detail.

For example, splicer 150 includes input buffers, output buffers, switching circuitry and internal logic circuitry adapted to achieve the functions to which the splicer 150 is directed. The splicer 150 also includes communications circuitry adapted to communicate with the controller 170. In alternate embodiments, the functions associated with the controller 170 are included within the splicer 150. In one embodiment, the splicer 150 includes an ability to examine RTP and/or other transport header packet structures to identify therein information useful in implementing the present methodologies. In other embodiments, the controller 170 performs this function by extracting transport header information (RTP, MPEG-2 and so on) from input buffers associated with the splicer 150.

Similarly, the ad server 160 may comprise a local or remote server or network element adapted to provide advertising or other content streams to the splicer 150. The ad server 160 is depicted as communicating such advertising or other content streams directly with the splicer 150. However, in other embodiments, the ad server 160 is located remotely with respect to the splicer 150, such as a network element communicating with the splicer 150 via the network 140. The ad server 160 may be periodically refreshed by a content source (not shown), which content source may be local or remote with respect to the ad server 160. For example, the ad server 160 may be in communication with the content source via the network 144 periodic advertising/content refresh.

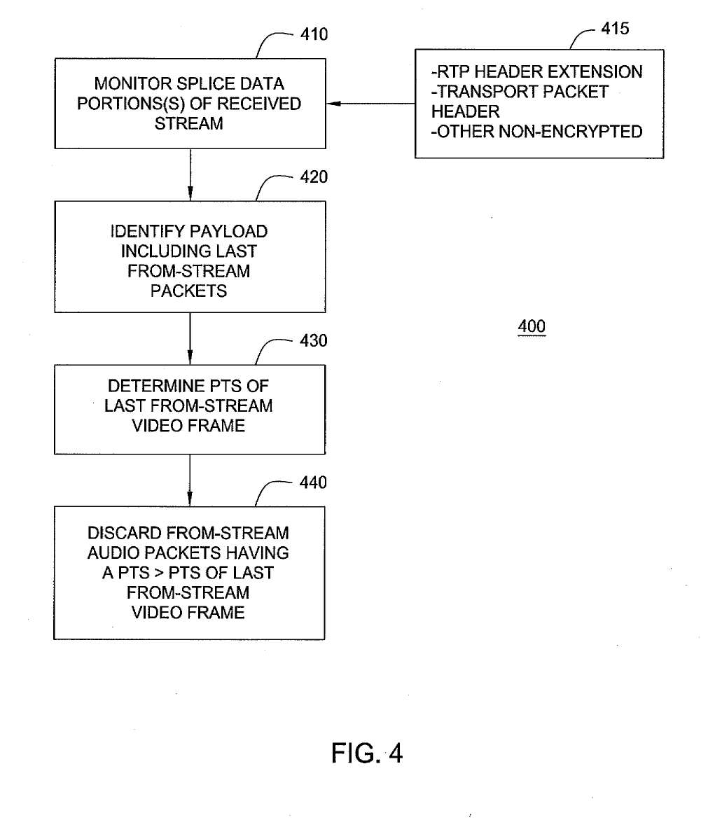

FIG. 4 depicts a flow diagram of a method for splicing or concatenating two compressed streams, such as where one of the compressed streams includes encrypted data such as described above with respect to FIG. 2.

At step 410, the controller 170 monitors the splice data portion or portions of a received stream, such as the stream or sequence of RTP encrypted transport packets TR′ described above. Referring to box 415, the monitor displays data portions which may comprise RTP headers or header extensions, transport packet headers or header extensions, MPEG-2 transport packet headers or header extensions and/or other non-encrypted portions of the received stream.

At step 420, the controller 170 identifies a payload including the last packets associated with a from-stream. For example, the dandified payload may comprise packets associated with an I-frame, a GOP boundary, a splice-out point and the like.

At step 430, the controller 170 determines the PTS of the last from-stream of the video frame. That is, the controller 170 determines which of the video frames within the from-stream will be the last video frame prior to the splice point.

At step 440, the controller 170 causes the splicer 150 to discard those from-stream audio packets associated with audio access units having a PTS greater than the PTS of the last from-stream video frame. The discarding may be achieved using functional elements within the splicer 150 or decryptor/decoder 180.

In various embodiments, the audiovisual streams comprise MPEG-2 transport streams encapsulating or otherwise conveying encrypted MPEG-2, MPEG-4, or other encoded/compressed elementary streams (video and audio access units). Further, the MPEG-2 transport streams may be conveyed according to the Real-time Transport Protocol (RTP) conventions.

One aspect of the invention is that it operates at a packet level. This is because the content stream (e.g., a network stream including both content and default advertisements) is encrypted such that information normally available to a seamless splicer is no longer available. Such information may comprise identifiers for splice in-points, splice out-points and other MPEG-2 structures useful in performing a seamless splicing operation.

### Other Embodiments

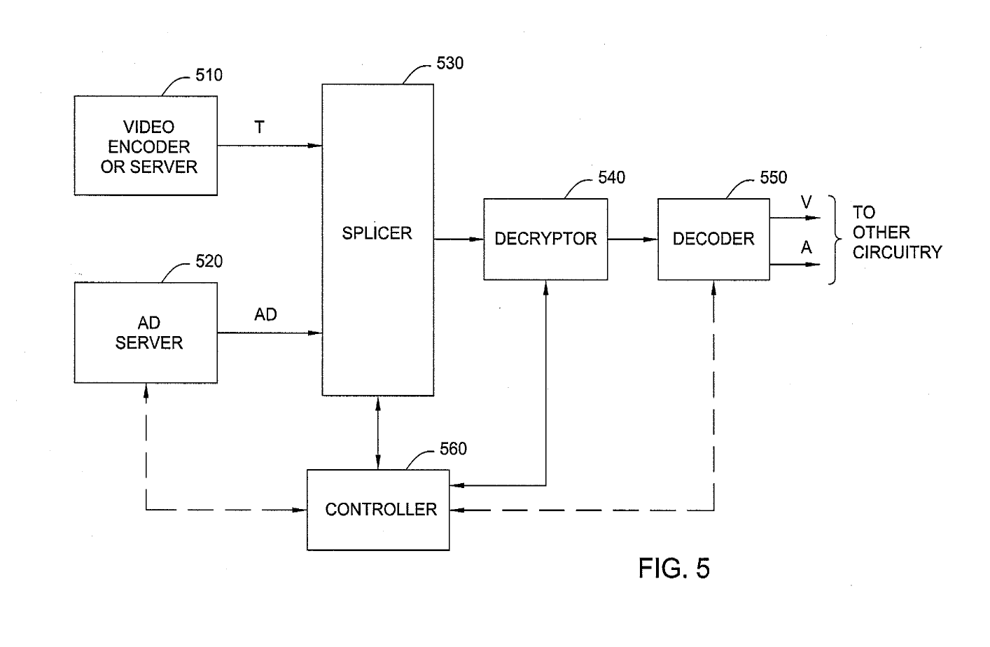

FIG. 5 depicts a high-level block diagram of a system according to another embodiment. Specifically, the system 500 FIG. 5 includes a video encoder or server 510, an advertising server 520, a splicer 530, a decryptor 540, a decoder 550 and a controller 560. Each of these elements operated in substantially the same manner as described above with respect to FIGS. 1-4. Generally speaking, the system 500 FIG. 5 provides a mechanism for implementing local advertising insertion at, illustratively, a neighborhood head end or router, an access network switching node, a network gateway device or any other device used to route or otherwise convey audiovisual content to subscriber terminals, computers and the like. As previously noted, the splicer 530 provides packet level splicing to concatenate a content bearing stream T2 and advertisements bearing stream AD (or vice versa).

The splicing operations discussed above with respect to the various FIGs. primarily contemplated the concatenating of a single from-stream and a single to-stream. As a practical matter, splicing operations will concatenate multiple streams to produce a concatenated stream having alternating sequences of stream portions derived from different input streams. Thus, in every instance where one stream is concatenated with another stream, the audio packets associated with the earlier stream are discarded so that they do not cause improper audio reproduction when the concatenated stream is presented. These earlier stream audio packets are discarded in response to their PTS being greater than the PTS of a final pre-splice video frame associated with the earlier stream.

FIG. 6 depicts a high-level block diagram of a computer (computing element) suitable for use in performing various functions described herein. Specifically, the computer 600 depicted in FIG. 6 provides a general architecture and functionality suitable for implementing at least portions of the functional elements described herein, such as the encoder 105, encryptor 115, transport packetizer 120, RTP packetizer 125, controller 130, splicer 150, advertising server 160, controller 170 and/or decryptor/decoder 180 described above with respect to FIG. 1. Additionally, the computer 600 depicted in FIG. 6 provides a general architecture and functionality for implementing at least portions of the functional elements described herein, such as the video encoder or server 510, advertising server 520, splicer 530, decryptor 540, decoder 550 and/or controller 560 described above with respect to FIG. 5.

As depicted in FIG. 6, computing element 600 includes various cooperating elements, including a processor element 602 (e.g., a central processing unit (CPU) and/or other suitable processor(s)), a memory 604 (e.g., random access memory (RAM), read only memory (ROM), and the like) and various input/output devices 606 (e.g., a user input device (such as a keyboard, a keypad, a mouse, and the like), a user output device (such as a display, a speaker, and the like), an input port, an output port, a receiver/transmitter (e.g., an air card or other suitable type of receiver/transmitter), and storage devices (e.g., a hard disk drive, a compact disk drive, an optical disk drive, and the like)). FIG. 6 also depicts a further cooperating element 605 that may be used to augment the functionality of the processor(s) 602, memory 604 and I/O devices 606 or to implement any of the various or additional functions as described herein. In various alternate embodiments, cooperating element 605 may comprise a control function client, control function server, control function agent, bearer function, management function and the like.

It should be noted that functions depicted and described herein may be implemented in software and/or in a combination of software and hardware, e.g., using a general purpose computer, one or more application specific integrated circuits (ASIC), and/or any other hardware equivalents. In one embodiment, software implementing methodology or mechanisms supporting the various embodiments is loaded into memory 604 and executed by processor(s) 602 to implement the functions as discussed herein. Thus, various methodologies and functions (including associated data structures) can be stored on a computer readable storage medium, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in tangible fixed or removable media, transmitted via a data stream in a tangible or intangible broadcast or other signal bearing medium, and/or stored within a memory within a computing device operating according to the instructions.

The various embodiments are especially useful within our systems and methods for splicing encrypted audiovisual streams, such as within the context of a network feed including content streams having default or nationally relevant advertisement portions which may be replaced by updated or local advertisement portions. In essence, encryption tolerant splicing methodologies are provided wherein selected portions of encrypted audiovisual stream are replaced in a substantially seamless manner for advertising insertion, fast channel change or other purposes.

Although various embodiments which incorporate the teachings of the present invention have been shown and described in detail herein, those skilled in the art can readily devise many other varied embodiments that still incorporate these teachings. Various aspects of the invention are specified in the claims. Those and other aspects of the invention are also specified in the following numbered clauses:

What is claimed is:

1. A method for splicing transport streams including encrypted audiovisual information to provide a concatenated transport stream, the method comprising:
identifying a presentation timestamp (PTS) of a final video frame of a from-stream; and
discarding from the from-stream those audio packets associated with any audio access unit having a PTS greater than the PTS of the final video frame of the from-stream.

2. The method of claim 1, wherein the from-stream comprises a network feed and a to-stream comprises an advertisement to be inserted.

3. The method of claim 1, wherein the from-stream comprises a stream of RTP packets encapsulating non-RTP transport packets including encrypted MPEG-2 video and audio elementary streams.

4. The method of claim 1, wherein the from-stream comprises a stream of RTP packets encapsulating non-RTP transport packets including encrypted MPEG-4 video and audio elementary streams.

5. The method of claim 3, wherein the non-RTP transport packets comprise MPEG-2 transport packets.

6. The method of claim 4, wherein the non-RTP transport packets comprise MPEG-2 transport packets.

7. The method of claim 1, wherein the encrypted audiovisual information comprises audiovisual information encrypted according to the Data Encryption Standard (DES) or the Triple DES.

8. The method of claim 1, further comprising:
receiving, at a splicer, a control signal indicative of a desire to change output transport streams; and
examining header information within the from-stream to determine a specific from-stream transport stream packet including the final video frame of the from-stream.

9. The method of claim 1, wherein the presence of a video frame suitable for use as final from-stream video frame is indicated via a splice data field within a transport stream packet header.

10. The method of claim 9, wherein the splice data field indicates the presence of the end of the group of pictures (GOP).

11. The method of claim 9, wherein the splice data field indicates at least one of the presence of the end of a group of pictures (GOP), a splice-out point, an I-frame, a beginning of a GOP and a splice-in point.

12. The method of claim 9, wherein the splice data field is part of an RTP transport packet header and operative to indicate that non-RTP transport packets encapsulated within a corresponding RTP transport packet payload include a video frame suitable for use as final from-stream video frame.

13. The method of claim 12, wherein the non-RTP transport packets comprise MPEG-2 transport packets.

14. The method of claim 9, wherein the splice data field is part of a non-RTP transport packet header and operative to indicate that a corresponding non-RTP transport packet payload includes a video frame suitable for use as final from-stream video frame.

15. The method of claim 14, wherein the non-RTP transport packets comprise MPEG-2 transport packets.

16. Apparatus, comprising:
a splicer, for splicing two transport streams including encrypted audiovisual information to provide a concatenated transport stream; and
a controller, for examining from-stream transport stream header information to identify a presentation time stamp (PTS) of a final from-stream video frame, and for deleting from-stream audio packets associated with a PTS later than the PTS of the final from-stream video frame.

17. The apparatus of claim 16, wherein the apparatus is included within a neighborhood head end servicing a plurality of subscriber terminals, the apparatus further comprising an advertising server for providing an advertisement bearing transport stream to the splicer as a to-stream.

18. The apparatus of claim 17, wherein the concatenated transport stream comprises a content bearing from-stream and an advertisement bearing to-stream.

19. The apparatus of claim 18, wherein the splicer further splices the content bearing transport stream onto the advertisement bearing transport stream to adapt the concatenated transport stream.

20. The apparatus of claim 16, wherein the apparatus is included within an access network switching node.

21. The apparatus of claim 16, wherein the apparatus is included within a network gateway device.

22. A computer readable medium for storing computer instructions which, when executed by a processor, perform a method for splicing transport streams including encrypted audiovisual information to provide a concatenated transport stream, the method comprising:
identifying a presentation timestamp (PTS) of a final video frame of a from-stream; and
discarding from the from-stream those audio packets associated with any audio access unit having a PTS greater than the PTS of the final video frame of the from-stream.

23. A computer program product wherein computer instructions, when processed by a computer, adapt the operation of the computer to perform a method for splicing transport streams including encrypted audiovisual information to provide a concatenated transport stream, the method comprising:
identifying a presentation timestamp (PTS) of a final video frame of a from-stream; and
discarding from the from-stream those audio packets associated with any audio access unit having a PTS greater than the PTS of the final video frame of the from-stream.
